(19) United States
(12) Patent Application Publication
(10) Pub. No.: US 2006/0181768 A1
(43) Pub. Date: Aug. 17, 2006

(54) Focus assisting method

(75) Inventors: Sheng-Chi Chan, Taichung (TW); Shih-Hsun Chan, Taichung (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Asia Optical Co., Inc.

(21) Appl. No.: 11/208,082

(22) Filed: Aug. 19, 2005

(30) Foreign Application Priority Data
Feb. 16, 2005 (TW) 94104444

(51) Int. Cl. G02B 1/00; G02B 23/00

(52) U.S. Cl. 359/410; 359/421

(57) ABSTRACT

A focus assisting method for a binocular image-taking apparatus. The binocular image-taking apparatus aims at a target such that the image of the target is received by an image-taking member. The image of the target received by the image-taking member is magnified to a predetermined ratio and the magnified image thereof is displayed on a display member. The position of an objective lens with respect to a beam splitter is adjusted to obtain an optimal clarified image of the target on the display member. The magnified image of the target on the display member is restored to an original size.

### BACKGROUND

The invention relates to a focus assisting method, and in particular to a focus assisting method for a binocular image-taking apparatus.

A digital camera often provides optical and digital zoom functions. Referring to FIG. 1, a conventional digital camera 1 comprises an objective lens assembly 11, an eyepiece lens assembly 12, and a CCD 13. The objective lens assembly 11 is disposed at the front of the digital camera 1 while the eyepiece lens assembly 12 is disposed between the objective lens assembly 11 and the CCD 13. When the digital camera 1 captures the image of a target S1, the objective lens assembly 11 performs optical zoom adjustment of the image of the target S1. Specifically, the objective lens assembly 11 moves in a direction indicated by an arrow A to zoom in or zoom out the image of the target S1 on the CCD 13. Focus adjustment of the image on the CCD 13 is then performed. Generally, the image of the target S1 on the CCD 13 is magnified to a predetermined ratio by a digital zoom, and the magnified image on the CCD 13 is displayed on an LCD (not shown). The eyepiece lens assembly 12 then moves in a direction indicated by an arrow B to adjust the focus of the target S1 imaged on the CCD 13, thereby adjusting definition of the magnified image of the target S1 displayed on the LCD. The image of the target S1 displayed on the LCD is restored to an original size of which the digital zoom does not operate. The digital camera 1 can then capture the clarified image of the target S1 by pressing a shutter (not shown) thereof.

### SUMMARY

Accordingly, an exemplary embodiment of the invention provides a focus assisting method for a binocular image-taking apparatus comprising an objective lens tube, a beam splitter, an eyepiece lens tube, an image-taking member, a display member, a frame body, and a screw assembly. An objective lens assembly is disposed in the objective lens tube. The screw assembly is connected to the objective lens tube. An eyepiece lens assembly is disposed in the eyepiece lens tube. The eyepiece lens tube is rotatably connected to the frame body. The focus assisting method comprises the steps of aiming the binocular image-taking apparatus at a target such that the image of the target is received by the image-taking member, magnifying the image of the target received by the image-taking member to a predetermined ratio and displaying the magnified image thereof on the display member, adjusting the objective lens tube by the screw assembly to alter the position of the objective lens assembly with respect to the beam splitter, obtaining an optimal clarified image of the target on the display member, and restoring the magnified image of the target on the display member to an original size.

In an embodiment of the focus assisting method, the image of the target is magnified by digital zoom.

In an embodiment of the focus assisting method, the image of the target is magnified automatically or manually.

In an embodiment of the focus assisting method, the magnified image of the target on the display member is manually restored to the original size.

In an embodiment of the focus assisting method, the focus assisting method further comprises a step of rotating the eyepiece lens tube to alter the position of the eyepiece lens assembly with respect to the beam splitter after the image displayed on the display member is restored to the original size, obtaining a clarified image of the target from the eyepiece lens tube.

### DESCRIPTION OF THE DRAWINGS

The invention can be more fully understood by reading the subsequent detailed description and examples with references made to the accompanying drawings, wherein:

FIG. 1 is a schematic view of the inner structure of a conventional digital camera;

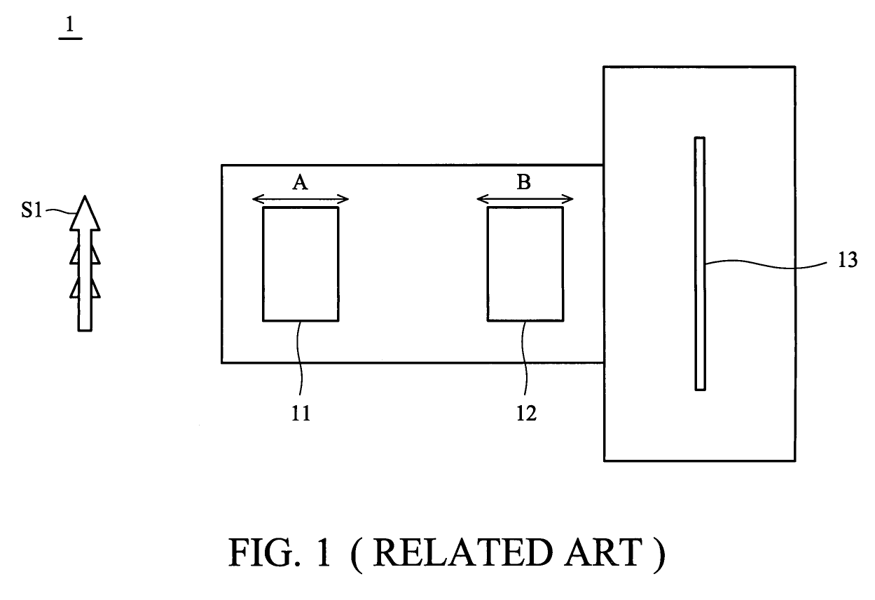

FIG. 2A is a schematic perspective view of a binocular image-taking apparatus applying the focus assisting method of the invention;

FIG. 2B is a schematic perspective view of the inner structure of a binocular image-taking apparatus applying the focus assisting method of the invention;

FIG. 3 is a schematic plan view of the inner structure of a binocular image-taking apparatus applying the focus assisting method of the invention;

FIG. 4 is a schematic plan view showing operation of the inner structure of a binocular image-taking apparatus applying the focus assisting method of the invention;

FIG. 5 is another schematic plan view showing operation of the inner structure of a binocular image-taking apparatus applying the focus assisting method of the invention; and

FIG. 6 is a flowchart of the focus assisting method of the invention.

### DETAILED DESCRIPTION

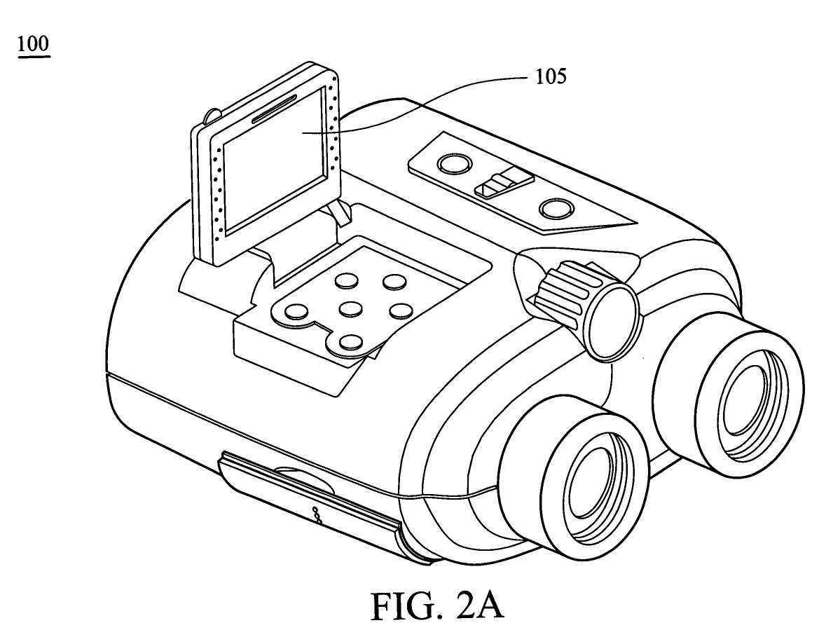

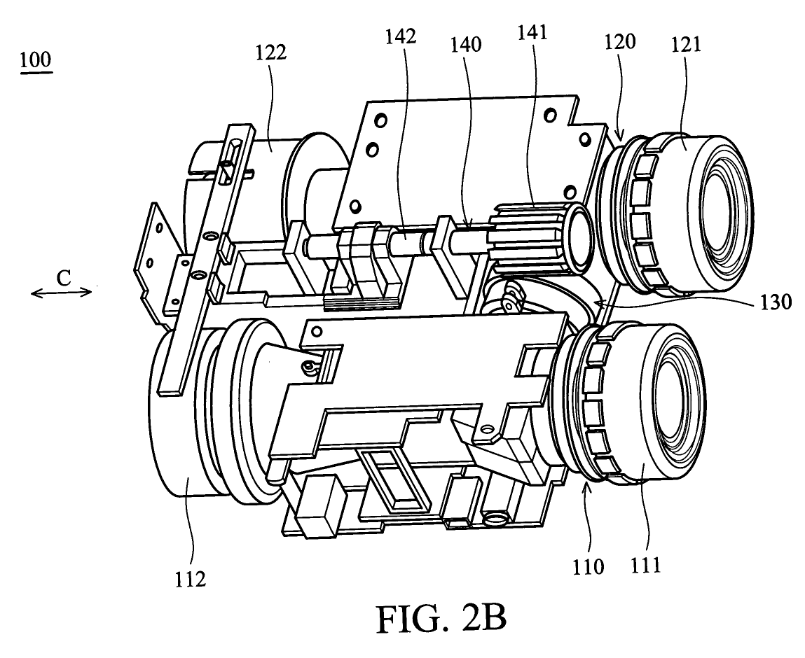

Referring to FIG. 2A, a binocular image-taking apparatus 100 comprises a display member 105, such as an LCD. The display member 105 can display images received by an image-taking member disposed in the binocular image-taking apparatus 100.

Referring to FIG. 2B, the binocular image-taking apparatus 100 comprises a first lens tube 110, a second lens tube 120, a frame body 130, and a screw assembly 140.

The first lens tube 110 and second lens tube 120 are parallel and connected to the frame body, 130. A digital camera module (not shown in FIG. 2A and FIG. 2B) is selectively disposed between the first lens tube 110 and the frame body 130 or between the second lens tube 120 and the frame body 130. Additionally, the first lens tube 110 comprises a first eyepiece lens tube 111 and a first objective lens tube 112, and the second lens tube 120 comprises a second eyepiece lens tube 121 and a second objective lens tube 122. The first eyepiece lens tube 111 and second eyepiece lens tube 121 are rotatably connected to the first lens tube 110 and second lens tube 120, respectively.

The screw assembly 140 is connected to the frame body 130, first objective lens tube 112, and second objective lens tube 122 and comprises a dial 141 and a screw shaft 142 connected to the dial 141. Specifically, by turning the dial 141 to move the screw shaft 142, the first objective lens tube 112 and second objective lens tube 122 can move in a direction indicated by an arrow C.

Moreover, the display member 105 can be disposed at any position in the frame body 130 to display images.

The following description is directed to operation of the binocular image-taking apparatus 100, in which a digital camera module 150 is disposed between the first lens tube 110 and the frame body 130.

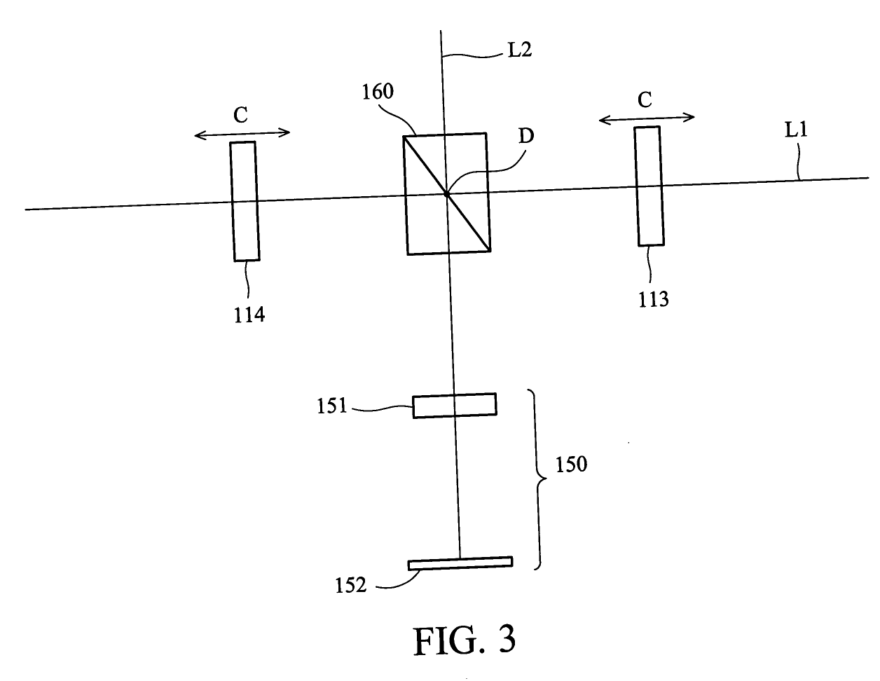

As shown in FIG. 2B and FIG. 3, a first eyepiece lens assembly 113 is disposed in the first eyepiece lens tube 111, and a first objective lens assembly 114 is disposed in the first objective lens tube 112. The first eyepiece lens assembly 113 can move in the direction indicated by the arrow C by turning the first eyepiece lens tube 111. The first objective lens assembly 114 can also move in the direction indicated by the arrow C by turning the dial 141 of the screw assembly 140. Specifically, the first eyepiece lens assembly 113 opposes the first objective lens assembly 114, and the first eyepiece lens assembly 113 and first objective lens assembly 114 have the same first optical axis L1. The digital camera module 150 comprises a focus lens assembly 151 and an image-taking member 152, such as a CCD or a CMOS. To simplify the structure of the binocular image-taking apparatus 100 and reduce the volume thereof, the focus lens assembly 151 is fixed in the binocular image-taking apparatus 100. Additionally, a beam splitter 160 is disposed between the first eyepiece lens assembly 113 and the first objective lens assembly 114 and on the first optical axis L1 of the first eyepiece lens assembly 113 and first objective lens assembly 114. The focus lens assembly 151 is disposed between the beam splitter 160 and the image-taking member 152. Specifically, a predetermined included angle exists between a second optical axis L2 of the focus lens assembly 151 and the first optical axis L1. The beam splitter 160 is disposed on an intersection D of the first optical axis L1 and second optical axis L2. Specifically, the focal point of the focus lens assembly 151 is on the intersection D and image-taking member 152. Namely, the focus of the focus lens assembly 151 equals the distance between the focus lens assembly 151 and the intersection D and between the focus lens assembly 151 and the image-taking member 152.

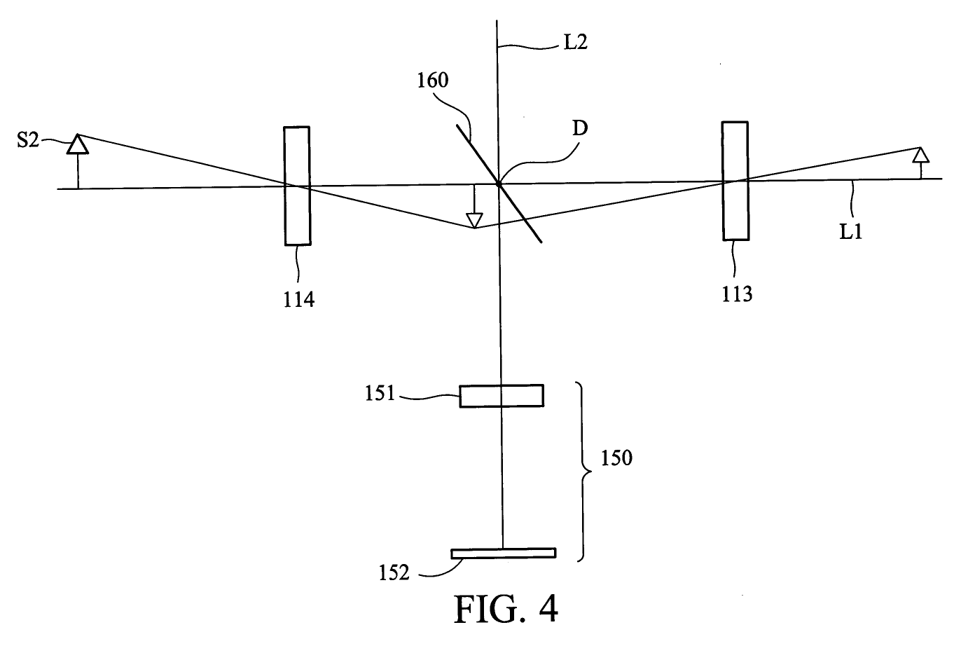

Referring to FIG. 4, when the binocular image-taking apparatus 100 aims at a remote target S2, the target S2 is imaged between the first objective lens assembly 114 and the first eyepiece lens assembly 113 via the first objective lens assembly 114. The target S2 is then imaged behind the first eyepiece lens assembly 113 via the first eyepiece lens assembly 113. Human eyes can be behind the first eyepiece lens assembly 113. Accordingly, the positions of the first eyepiece lens assembly 113 and first objective lens assembly 114 can be simultaneously adjusted by turning the first eyepiece lens tube 111 and dial 141 of the screw assembly 140 to respectively move the first eyepiece lens assembly 113 and first objective lens assembly 114, adjusting the imaging position of the target S2 behind the first eyepiece lens assembly 113. The imaging position of the target S2 can thus be adjusted to be on the retinas of the human eyes. At this point, the human eyes can capture a clarified image of the target S2.

Nevertheless, as shown in FIG. 4, when the human eyes capture the clarified image of the target S2, the imaging position of the target S2 through the first objective lens assembly 114 is not on the focal point (intersection D) of the focus lens assembly 151. The image of the target S2 cannot be focused on the image-taking member 152 after passing through the focus lens assembly 151. Namely, the image of the target S2 clearly captured by the human eyes cannot be clearly received or taken by the digital camera module 150 (or image-taking member 152).

Accordingly, the digital camera module 150 (or image-taking member 152) can take a clarified image of the target S2 using the present focus assisting method.

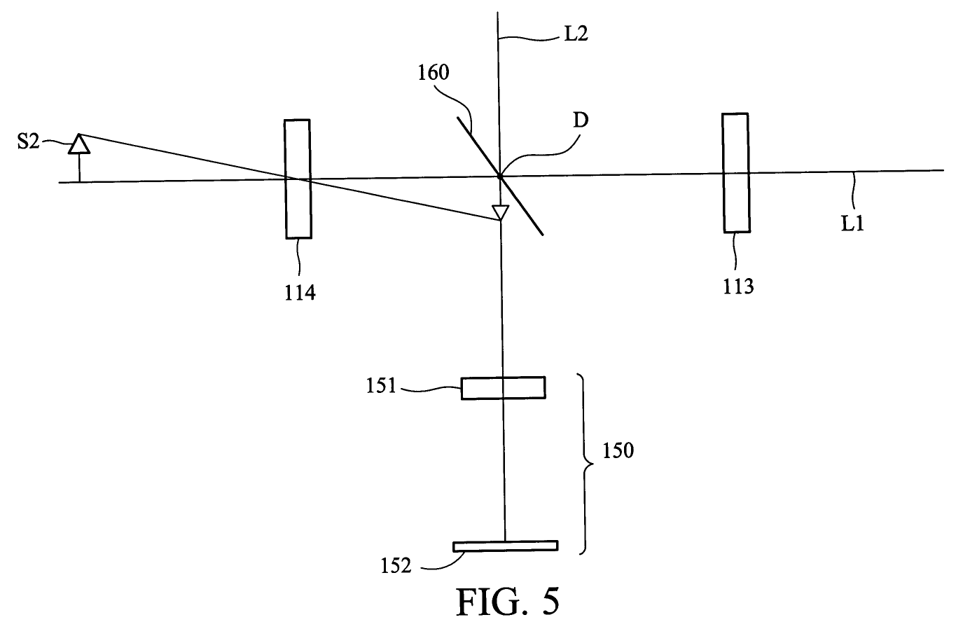

The image of the target S2 on the image-taking member 152 is magnified to a predetermined ratio, such as 3 times, by digital zoom. The magnified image of the target S2 is displayed on the display member 105 (LCD) Namely, the image of the target S2 is magnified to the predetermined ratio by a digital manner. Moreover, the image of the target S2 can be magnified automatically or manually. As shown in FIG. 2B and FIG. 5, the dial 141 of the screw assembly 140 is turned to move the first objective lens assembly 114 until the magnified image of the target S2 is focused exactly on the focal point (intersection D) of the focus lens assembly 151. At this point, the magnified image of the target S2 on the display member 105 (LCD) is clarified. The magnified image of the target S2 can be restored to the original size by pressing any button on the binocular image-taking apparatus 100. The first eyepiece lens assembly 113 can then be adjusted to allow the human eyes to clearly capture the image of the target S2 focused on the intersection D via the first eyepiece lens assembly 113. At this point, definition of the image taken by the image-taking member 152 is not adversely affected. The digital camera module 150 (or image-taking member 152) can then take a clarified image of the target S2 by pressing a shutter (not shown) of the binocular image-taking apparatus 100.

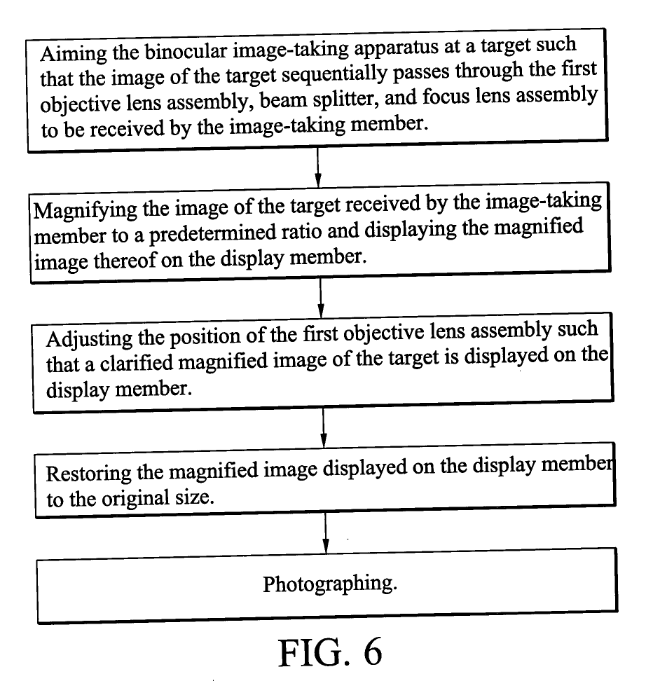

Moreover, the aforementioned focus assisting method is described by a flowchart depicted in FIG. 6.

In conclusion, during a focusing operation of a binocular image-taking apparatus, whether the image of a remote target received by an image-taking member (CCD) or displayed on a display member (LCD) is exactly focused can be decided by the disclosed focus assisting method. Namely, the disclosed focus assisting method can enhance accuracy of the focusing operation when the binocular image-taking apparatus focuses on the remote target.

While the invention has been described by way of example and in terms of preferred embodiment, it is to be understood that the invention is not limited thereto. To the contrary, it is intended to cover various modifications and similar arrangements (as would be apparent to those skilled in the art) Therefore, the scope of the appended claims should be accorded the broadest interpretation so as to encompass all such modifications and similar arrangements.

What is claimed is:

1. A focus assisting method for a binocular image-taking apparatus comprising an objective lens, a beam splitter, an eyepiece lens, an image-taking member, and a display member, comprising:
aiming the binocular image-taking apparatus at a target such that the image of the target is received by the image-taking member;
magnifying the image of the target received by the image-taking member to a predetermined ratio and displaying the magnified image thereof on the display member;
adjusting the position of the objective lens with respect to the beam splitter to obtain an optimal clarified image of the target on the display member; and
restoring the magnified image of the target on the display member to an original size.

2. The focus assisting method as claimed in claim 1, wherein the image of the target is magnified by digital zoom.

3. The focus assisting method as claimed in claim 1, further comprising:
adjusting the eyepiece lens to obtain a clarified image of the target therefrom after the image displayed on the display member is restored to the original size.

4. A focus assisting method for a binocular image-taking apparatus comprising an objective lens assembly, a beam splitter, a focus lens assembly, an image-taking member, an eyepiece lens assembly, and a display member, wherein, when a target is imaged via the objective lens assembly, the image of the target is respectively transmitted to the focus lens and eyepiece lens assemblies via the beam splitter, comprising:
magnifying the image of the target received by the image-taking member to a predetermined ratio and displaying the magnified image thereof on the display member;
adjusting the position of the objective lens assembly with respect to the beam splitter to obtain an optimal clarified image of the target on the display member; and
restoring the magnified image of the target on the display member to an original size.

5. The focus assisting method as claimed in claim 4, wherein the image of the target is magnified by digital zoom.

6. The focus assisting method as claimed in claim 4, further comprising:
adjusting the eyepiece lens assembly to obtain a clarified image of the target therefrom after the image displayed on the display member is restored to the original size.

7. A focus assisting method for a binocular image-taking apparatus comprising an objective lens tube, a beam splitter, an eyepiece lens tube, an image-taking member, a display member, a frame body, and a screw assembly, wherein an objective lens assembly is disposed in the objective lens tube, the screw assembly is connected to the objective lens tube, an eyepiece lens assembly is disposed in the eyepiece lens tube, and the eyepiece lens tube is rotatably connected to the frame body, comprising:
aiming the binocular image-taking apparatus at a target such that the image of the target is received by the image-taking member;
magnifying the image of the target received by the image-taking member to a predetermined ratio and displaying the magnified image thereof on the display member;
adjusting the objective lens tube by the screw assembly to alter the position of the objective lens assembly with respect to the beam splitter, obtaining an optimal clarified image of the target on the display member; and
restoring the magnified image of the target on the display member to an original size.

8. The focus assisting method as claimed in claim 7, wherein the image of the target is magnified by digital zoom.

9. The focus assisting method as claimed in claim 7, further comprising:
rotating the eyepiece lens tube to alter the position of the eyepiece lens assembly with respect to the beam splitter after the image displayed on the display member is restored to the original size, obtaining a clarified image of the target from the eyepiece lens tube.
